(19) United States
(12) Patent Application Publication
(10) Pub. No.: US 2005/0015802 A1
(43) Pub. Date: Jan. 20, 2005

(54) Control broadcast programme signal, control write and read systems, related production and broadcasting channel

(76) Inventor: Jean-Michel Masson, Acigne (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/494,723

(22) PCT Filed: Nov. 15, 2002
(86) PCT No.: PCT/FR02/03921

(30) Foreign Application Priority Data
Nov. 16, 2001 (FR) 01/4857

(51) Int. Cl. H04N 5/445; G06F 3/00; H04N 7/10; H04N 7/025; H04N 7/084; H04N 7/08; H04N 7/16

(52) U.S. Cl. 725/40; 348/473; 725/32; 725/135; 725/136

(57) ABSTRACT

The invention relates to programs enhanced by applications. It relates, furthermore, to the associated production and broadcasting systems, in particular to interactive digital television. The activation of an interactive application associated with a broadcast program may be done manually in the broadcasting channel. This solution is expensive, lacks accuracy, and the control of the application is managed not by the production channel but the broadcasting channel. The invention therefore proposes to use a broadcasting program signal comprising primary data for the reproduction of the passive main content of the program and secondary data watermarked in the primary data. These secondary data comprise the commands for triggering at least one application such as, in particular, the controlling of one or more broadcasting parameters of said program signal and/or of one or more applications, for example interactive or broadcasting, related to said program signal.

The invention relates to programs enhanced by applications, in particular by interactive applications and/or broadcasting applications. It relates, furthermore, to the associated production and broadcasting systems, in particular to interactive digital television.

Interactive televised programs exist today but have said interactive content as their sole content. For example, home banking, weather or cooking channels, etc. These are programs dedicated to an interactive |content, this interactive content occupying the entire screen. The program being totally dedicated to the interactive content, it is easy to limit its use to subscribers alone through encryption for example. The encryption key is then provided to the subscribers under specified conditions, payment of a subscription for example. These programs having only interactive content therefore make it possible to target their users.

More generally, interactive television consists in enhancing traditional television, that is to say the passive viewing of a video program, through contextual applications, known as “enhanced TV”. The background of the screen therefore remains occupied by the video program to which information is added by way of the decoder. This information allows the user to interact by virtue of the remote control of the decoder. The interactivity then pertains to a predefined video sequence or even to a single video image.

For example, during televised games, the viewer himself can also respond to questions at the same time as the candidates with the possibility of winning prizes. Another example is to allow the viewer to vote live without having to pick up their telephone by simply pressing one of the buttons of their remote control (such as for electing Miss, singer, etc.). Interactive television can also be beneficial in respect of telepurchase transmissions, making it possible, for example, at any moment during the transmission to put into a virtual basket or to remove therefrom the objects that one wishes to order and then to place the order, all of this by simply pressing the buttons of one's remote control while not budging from in front of one's television set. Interactive advertisements can also be envisaged, offering samples or a trial of the object of the advertisement. Or else games on which the viewer can bet like horse racing, etc.

The use of the remote control as interaction interface simplifies the implementation of interactivity for the viewer and reduces the costs since it is not necessary to purchase a particular interface, telephone, Internet connection, suitable infrared keyboard etc. for example.

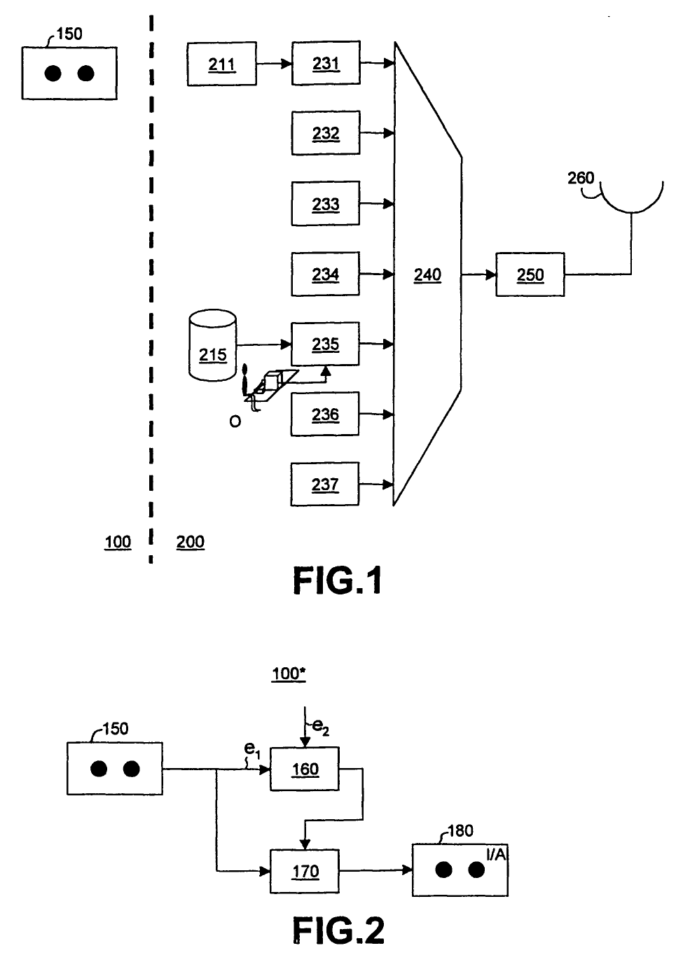

FIG. 1 diagrammatically shows the production and broadcasting channels for a video program according to the prior art. The production channel 100 makes it possible to obtain a video program stored on a cassette 150 sent to the broadcasting channel 200. This may for example be a professional video cassette containing the video program to be broadcast and commonly called the RTB, that is to say ready to broadcast. This RTB cassette 150 is then read by the video cassette reader VTR 211 of the broadcasting channel 200 (VTR is the abbreviation standing for Video Tape Reader). The video program is then coded by the video coder 231, it generally being an MPEG coder 2.

The multiplexer 240 receives several types of data. It processes the coded video program generated by the video coder 231. But also, for example, IP/MEPG data emanating from a server 233 are presented on another input of the multiplexer 240. They may for example cater for an Internet connection. The output of an EPG generator 233 (EPG is the abbreviation standing for electronic program guide) can be coupled to one of the inputs of the multiplexer 240. To cater for VOD video on demand services or NVOD near video on demand services, the signals generated by the device 234 are received by the multiplexer 240. For various reasons, it may be desirable to limit the access to certain programs. These reasons may be moral: programs intended for certain population brackets (adults, for example) or more simply financial: creation of profits on certain programs, etc. A device 236 then generates conditional access data associated with these programs, such as for example an encryption key. The multiplexer can also receive interactive data generated by the module 237 (for example, for interactive channels such as the weather channel, etc).

As far as the video programs enhanced by interactive applications are concerned, the interactive applications broadcasting device 235 will search for the interactive application to be broadcast during a period T in a server 215 and transmit it to the multiplexer 240.

The multiplexer 240 transmits all of these data after processing, in particular segmentation for packet transmission, to the modulator 250 for their broadcasting with the aid of at least one transmitting antenna 260.

It is conceivable to broadcast an interactive application over large timeslots thereby ensuring that the application is broadcast during its activation. However, the larger the timeslot for broadcasting the interactive applications, the more the bandwidth is occupied. Now, this bandwidth is limited, and therefore broadcasting over large timeslots limits the number of interactive applications broadcast simultaneously.

In the case of interactive applications synchronized with the video program, additional constraints have to be taken into account. The activation of an interactive application reprograms the user's decoder to receive his reaction (programming of the button(s) of the remote control for this interactive application) and possibly upload this reaction to the broadcaster 200. The activation of the interactive application may then be done manually by the intervention of an operator O at the level of the interactive applications broadcasting device 235. The device 235 for broadcasting interactive applications upon the intervention of the operator O transmits the command for triggering the activation of the interactive application identified by this command to the multiplexer 240. The operator O views the video program broadcast and manually triggers the activation of the interactive application via the interactive applications broadcasting device 235. The cost of the interactivity of the program is necessarily high on account of the use of an operator O. Moreover, an operator O is inaccurate, this being a drawback for interactive applications related to a single video image or to very short video sequences.

Another problem is that the production channel 100 normally loaded with the content of the programs does not manage the interactive content of the program in question but only its video content. The commands for triggering the broadcasting and the activation of an interactive application of the program are managed by the operator O of the broadcasting channel 200.

Should the video program be stored on a professional video cassette 150, a solution proposed in this case consists in writing the commands (known as triggers) for triggering at least the activation of the interactive applications in the video related data areas. In this case, both the video and the interactive content are managed by the production channel 100. Specifically, the production channel 100 provides the broadcasting channel 200 with a RTB cassette 150 on which is written the global content of the program: both the video and the instants of triggering of the interactive applications. However, the equipment handling the RTB cassettes 150 before broadcasting spoils the video related data area. Consequently, the triggering commands are deleted, at least in part. These techniques are therefore neither generic nor deployable since they are unreliable on account of the loss of triggering commands.

The present invention makes it possible to obviate these drawbacks by proposing to write commands for triggering applications intended for the broadcasting channel. In particular, these commands may be commands for triggering the interactive application in the program signal itself, for example, the video signal. In this way the data related to the application (interactive, broadcasting, etc) cannot be separated from the main content of the program, in particular the video. Hence, whatever the operations carried out on the program signal, in particular on the RTB cassette 150, the commands for triggering the application will survive. This makes it possible, in terms of utilization, to afford technical guarantees that the interactive program will be broadcast correctly, and then reproduced.

The invention therefore relates to a broadcasting program signal comprising primary data for the reproduction of the passive main content of the program, which comprises secondary data watermarked in the primary data. The secondary data do not alter the reproduction of the main content of the primary data.

These secondary data comprise the commands for triggering at least one application related to the main content of the primary data.

These secondary data make it possible to control the triggering of applications such as, in particular, the controlling of one or more broadcasting parameters of said program signal and/or of one or more applications related to said program signal.

Furthermore, the secondary data allow, for example, the triggering of the broadcasting and/or of the activation of at least one interactive application related to the main content of the primary data.

Another subject of the invention is a system for writing commands writing secondary data, allowing the triggering of at least one application, in a program signal comprising at least primary data for the reproduction of the passive main content of the program. This command writing system comprises:
a first input e₁ receiving primary data for the reproduction of the passive main content of the program,
a second input e₂ receiving predetermined control criteria,
a reproduction and editing device 160 coupled to these first and second inputs e₁ and e₂, said device 160 reproducing the main content of the primary data, which content is received on the first input e₁, and editing on its output at least one secondary datum making it possible to control the triggering of at least one application related to the main content of the primary data, which application is reproduced at this instant according to the predetermined interactivity criteria received on this second input e₂,
a watermarking device 170 receiving the primary data of the first input e₁ and secondary data, and generating a program signal comprising the primary data and the secondary data watermarked in the primary data, said watermarking not altering the reproduction of the main content of the primary data,
an output coupled to the output of the watermarking device 170.

In particular, the predetermined control criteria may be predetermined interactivity criteria, and said reproduction and editing device 160 can edit on its output at least one secondary datum making it possible to control the triggering of the broadcasting and/or of the activation of at least one interactive application related to the main content of the primary data, which application is reproduced at this instant according to said predetermined interactivity criteria received on this second input e₂.

The invention furthermore proposes a production channel comprising in series a system for producing a program signal comprising primary data for the reproduction of the passive main content of the program and a command writing system as described hereinabove.

The invention also relates to a system for reading a command in a program signal comprising primary data for the reproduction of the passive main content of the program and at least one secondary datum watermarked in the primary data. This command reading system 220 comprises:
a first input receiving the program signal,
a watermark reading device 221, reading the secondary data watermarked in the primary data, these secondary data comprises commands for triggering at least one application related to the main content of the primary data,
an output receiving triggering commands.

The secondary data transmitted on the output of the command reading system 220 may, furthermore, comprise synchronized commands such as for triggering the activation and/or the broadcasting of the interactive applications identified by the triggering commands is synchronized with the reproduction of the primary data in which the secondary data associated with these triggering commands are watermarked.

Optionally, the command reading system comprises a synchronization device 225 receiving at least the secondary data and generating said synchronized triggering commands.

According to the invention, a program broadcasting channel is proposed. It comprises several devices, including at least:
a device 221 for reading a program signal comprising primary data for the reproduction of the passive main content of the program and at least one secondary datum watermarked in the primary data,
a program signal coder 231 coupled to the output of said program signal reading device 221,
a command reading system 220 as claimed in one of claims 7 or 8 coupled to the output of said program signal reading device 211 and/or to the output of said program signal coder 231 and to the input of at least any one of the devices of said broadcasting channel, the triggering commands generated by the command reading system 220 controlling said device of said broadcasting channel, which device is coupled to said command reading system 220,
and/or an interactive applications server 215, a device for broadcasting interactive applications 235 coupled to said interactive applications server 215,
a multiplexer 240 coupled at least to the outputs of the program signal coder 231 and to the interactive applications broadcasting device 235.

Optionally, said command reading system 220 is coupled to said interactive applications broadcasting device 235, the triggering commands generated by the command reading system 220 controlling the transmission of the interactive applications originating from said interactive applications server 215 to the multiplexer 240 and/or the transmission to the multiplexer 240 of the order for activation of one or more interactive applications identified by these triggering commands.

The characteristics and advantages of the invention will become more clearly apparent on reading the description, given by way of example, and of the figures pertaining thereto which represent:

FIG. 1, a partial diagram of the production and broadcasting channels for video programs with interactive applications according to the prior art,

FIG. 2, a partial diagram of the production channel for video programs with interactive applications according to the invention,

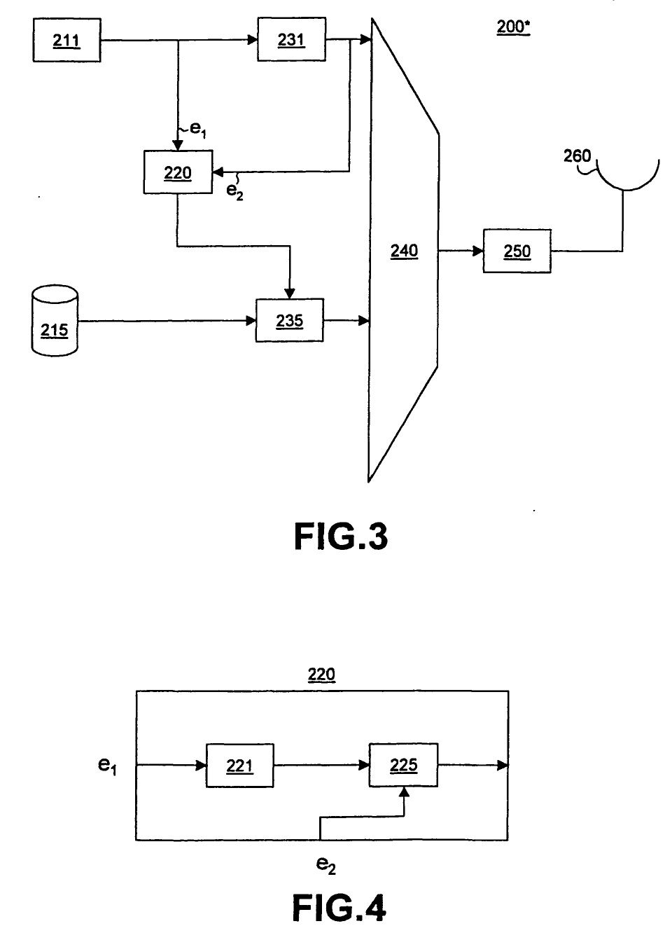

FIG. 3, a partial diagram of the broadcasting channel for video programs with interactive applications according to the invention,

FIG. 4, a diagram of the reading system according to the invention,

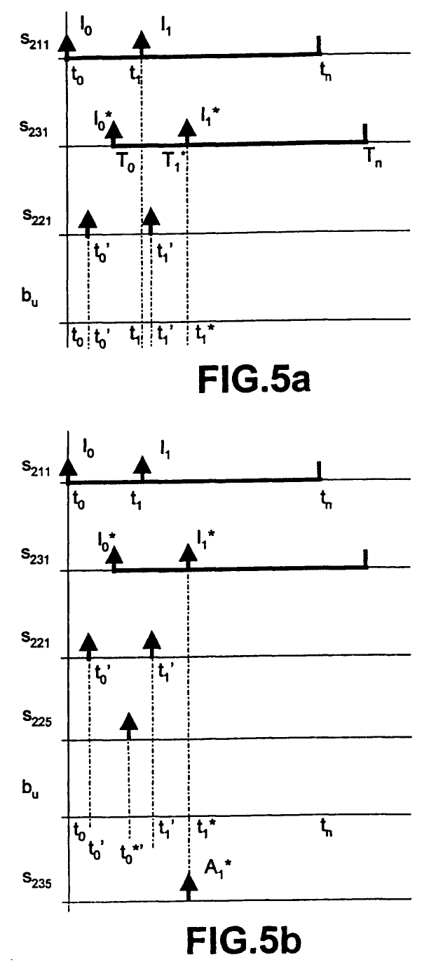

FIGS. 5a and 5b, diagrammatic representations of the progress of an image and of the associated interactive application in the broadcasting channel according to the invention, FIG. 5a corresponding to the use of an interactive system supporting the dispatching of explicit synchronization messages relating to the time base of the primary signal (in particular the MHP standard) and FIG. 5b corresponding to an interactive system for which the controlling of the activation of an interactive application can be done only by managing its instant of broadcasting in the signal received by the decoder (in particular the systems of OpenTV or MediaHighway type),

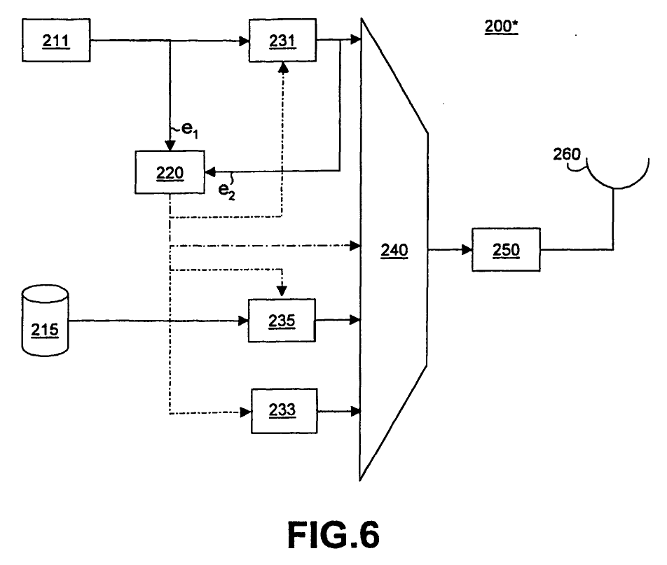

FIG. 6, a general partial diagram of the broadcasting channel for video programs with commands triggering various applications according to the invention.

The watermarking of primary data for the reproduction of the passive main content of the program by secondary data allowing the triggering of the broadcasting and/or of the activation of at least one interactive application related to the main content of the primary data implements two devices:
one responsible for writing the secondary data into the primary data sequence,
the other capable of detecting and of reading secondary data in a primary data signal.

In the command writing system envisaged by the invention, the watermarking device 170 is situated in the production channel 100* and coupled to a reproduction and editing device 160 from which it will receive the secondary data to be watermarked in the primary data, as is represented in FIG. 2.

The watermarked reading device 221 is situated in the broadcasting channel 200* as shown by FIG. 3. It is connected to a device 211 for reading the interactive program signal on the storage medium 180. The watermark reading device 221 controls, for example, the device for broadcasting the interactive applications 235.

FIG. 2 shows the part of the program production channel 100* dedicated to the installing of the means required to control the triggering of the applications, in particular to interactivity, according to the invention. The program signal comprising the primary data of the passive main content of the program are, for example, stored on a professional video cassette 150, in particular according to the CCIR 601 standard.

The reproduction and editing device 160 receives this program signal on its first input e₁. It reproduces the main content of the program on the basis of these primary data. Hence, if the main content of the program is visual, it displays the video image sequence. If it is an audio program, it broadcasts the sound sequence.

Control criteria which are, for example, interactivity criteria are received on a second input e₂ of this reproduction and editing device 160. These criteria may be various. The interactivity criteria are divided into two categories: one associated with the broadcasting of the interactive applications, the other with their activation. These criteria may comprise methods such as, for example, the calculation of the broadcasting slot of an interactive application as a function of the slot or of the instant of its activation (for example, beginning the broadcasting of the interactive application 5s after its activation and halting its broadcasting 5s after its activation), or else associate the activation of an interactive application with a sequence comprising a predetermined object (by recognition of the object in the content reproduced—recognition of an image or of sound—). The reproduction and editing device 160 then identifies the sequence with which must be associated using the method advocated.

These control criteria may also be fixed manually by an operator O* by virtue of an interface whose output is coupled to the input e₂ of the reproduction and editing device. Even if, here again, an operator is used, he intervenes only once. Whereas today, for a program stemming from a single production channel 100, if this program is broadcast by several broadcasting channels 200 or several times by one and the same broadcasting channel 200, the intervention of an operator O is necessary on each broadcasting channel 200 and is so for each broadcast. Hence, the global production cost is decreased by the intervention of a single operator O*.

Moreover, owing to the numerous interventions, not only is there a problem of inaccuracy as to the instant of activation of the application of interactive type with respect to the main content but moreover it will not be the same with each reproduction of the interactive program. Whereas a single operator O* intervening in the production channel 100* can, with the aid of the reproduction and editing device 160, view in the case of a video content, listen in the case of a sound content, etc. at different speeds or even image (video or sound, etc.) by image so as to obtain better accuracy in the associating of a given interactive application with a sequence or an image of the main content of the primary data.

The reproduction and editing device 160 then edits secondary data that are application triggering commands, in particular commands for triggering the broadcasting and/or activation of the interactive application associated with the image or the image sequence reproduced. The secondary data allowing the triggering comprises the index of the interactive application, and optionally a code making it possible to determine whether one is dealing with a command for triggering broadcasting (start or end of broadcasting) or activation if both types of information are produced.

There may therefore exist four types of secondary data for triggering an interactive application. The first intended for the activation of the interactive application and which are watermarked in the primary data sequences whose passive main content will be supplemented by the interactive application in question. The second intended for starting the broadcasting of the interactive application at the instant of broadcasting of the image primary data in which this secondary datum is watermarked. The third intended for stopping the broadcasting of the interactive application at the instant of broadcasting of the image primary data in which this secondary datum is watermarked. Moreover, a fourth type of secondary data may be envisaged. This is a synchronization message making it possible to identify the start of a video sequence. This message allows the reading device (211, 220) to calculate the temporal parameters necessary for the synchronization of the secondary data with the primary data.

The use of the second and third type of secondary data makes it possible to automate the process for broadcasting the interactive applications. Thus, bandwidth is saved. This is not the case today with the use of scheduling of timeslots for broadcasting interactive applications done manually. Manual configuration is a source of error and uses very considerable margins on the broadcasting period—several hours—giving rise to a loss of bandwidth.

Moreover, an identifier of the broadcaster for which the secondary data are intended may be envisaged, in particular for those data concerning the triggering of the broadcasting of the interactive application. Thus, a different broadcasting slot may be calculated according to the technical characteristics of each broadcasting channel 200*. The reproduction and editing device 160 then formulates different secondary data depending on the destination broadcasting channel 200*.

The secondary data edited by this reproduction and editing device 160 are transmitted to a watermarking device 170 (known as a watermark embedder). This watermarking device 170 furthermore receives the primary data of the program signal, which is for example stored on the RTB video cassette 150. The interactive program signal obtained at the output of the watermarking device 170 comprises the secondary data watermarked in the primary data.

This watermarking does not alter the reproduction of the passive main content of the primary data. This signifies, in particular in the case of a video passive main content, that the viewer cannot see the difference between the video image before and after watermarking. In the same way, the watermarking of a sound sequence should not be audible to the person listening to the interactive program.

For the watermarking of secondary data in video primary data, it is conceivable to call upon the method and device described by patent application WO 0065840. However, in general, any existing image or sound watermarking device or method may be implemented by this watermarking device 170.

The interactive program signal thus obtained by the watermarking device 170 is stored on a medium 180 which may again be a professional video cassette RTB.

The existing methods of image watermarking permitting the watermarking of words of different length of up to 64 bits, a secondary datum may be a word of up to 64 bits. However, the lighter (small number of bits) the word making up the secondary datum, the more robust this secondary datum would be. Specifically, this makes it possible, for example to write the secondary datum into a single image (video, sound, etc) several times or to write the secondary datum after coding by an error correcting code.

Let us take, for example, the case of secondary data composed of 32-bit words. A 32-bit secondary datum may then comprise 4 bits coding the type of triggering, optionally 4 bits identifying the destination broadcasting channel, 16 bits allowing identification of the interactive application, for example through its index in an interactive application server. This index follows, for example, the format specified by the standard used, in particular the MHP standard. The other 8 bits make it possible to reference an event in particular within the given interactive application.

FIG. 3 shows the part of the broadcasting channel 200* for the example of interactive program broadcasting dedicated to the installing of the means necessary for the control of triggering of an application such as interactivity according to the invention.

A reading device 211 for the storage medium 180 reads the program signal comprising the primary data and the watermarked secondary data. It transmits this signal to a primary datum coder 231, an audio coder if the primary data are audio, a video coder if they are video, etc. Furthermore, it transmits said program signal to a command reading system 220.

This command reading system 220 is capable of reading the secondary data watermarked in the primary data and of creating an order for controlling the device for broadcasting the interactive applications 235. This interactive application broadcasting device 235 transmitting to the multiplexer 240 upon an order from the command reading system 220 the interactive application to be broadcast that it will have searched for in the interactive applications server 215 and/or this application's activation order intended for the end user's decoder.

The order compiled by the command reading system 220 comprises the interactive application's identifier given by the secondary datum. In the case of a secondary datum for the triggering of broadcasting, it comprises a command intended for the interactive application broadcasting device 235 to start or stop the transmission of the identified interactive application from the interactive application server 215 to the multiplexer 240. In the case of a secondary datum for the triggering of activation, it comprises a command intended for the end user's decoder that the interactive application broadcasting device 235 transmits to the multiplexer 240. It is conceivable for the commands generated by the command reading system 220 to comprise information such that they are executable only by a single interactive application broadcasting device 235. This signifies that these devices 235 are identified by a unique value, so that there is selective processing of the broadcasting or activation commands. In this case, said interactive application broadcasting device 235 retranscribes only the commands intended for the decoder of the end user addressable by the broadcasting signal.

In all cases, the triggering commands generated by the command reading system 220 are synchronized with the image (sound, video, etc.) or the image sequence formed by the primary data and in which the secondary triggering data from which said command originated were watermarked. This synchronization is performed so that the broadcasting and/or the activation of the interactive application identified by the secondary datum is synchronized with the reproduction of the passive main content of the primary data, in which the secondary datum is watermarked.

In the example of FIG. 3, the command reading system 220 has two inputs, one coupled directly to the output of the program signal reading device 211, the other to the output of the primary data coder 231. FIG. 4 gives, in greater detail, a possible embodiment of this dual-input command reading system 220.

The first input e₁ of the command reading system 220 receives the program signal having undergone no processing and hence no attack apart from the reading from its storage medium 180. It is coupled to a watermark reading device 221 (known as a watermark reader). Since they have undergone hardly any processing, the secondary data are hardly affected by noise and their reading is more reliable. However, the triggering commands thus obtained are no longer synchronized with the image or the image sequence (sound, video, etc.) in which the secondary data from which they emanate was watermarked. This is all the more so when the primary data undergo, furthermore, at least one additional processing by virtue of the coder 231. This is why, a synchronization device 225 receives the triggering commands read by the watermark reading device 221. This synchronization device 225 is coupled to the second input e₂ of the command reading system 220. On this input, it receives data on the basis of which it is capable of calculating the delay of the commands for triggering of the secondary data with regard to the primary data so as to transform these triggering commands so that they are synchronized with the primary data.

In the example given in FIG. 3, this second input e₂ of the command reading system 220 is coupled to the output of the primary data coder 231. Thus, the synchronization device 225 takes account of the delay induced by the coding performed by the device 231 on the primary data.

The watermark reading device 221 is coupled directly with the output of the program signal reading device 211 since the watermarks are generally very sensitive to attacks, in particular to those induced by the coders such as the primary data coder 231. However, if the watermarking technique is sufficiently resistant (error rate less than a given threshold) to attacks of the broadcasting channel for the primary data 211-231, the watermark reading device 220 can be coupled in parallel with the input of the primary data in the multiplexer 240. In this case, according to the format of the signals transmitted to the decoders of the end user (middleware), the synchronization device would not be necessary since the triggering commands obtained by the watermark reading device would be synchronized.

Specifically, various formats of signals transmitted to the end user's decoders exist. The oldest formats are for property formants: OpenTV, MediaHighway, etc. The most recent: MHP is the DVB standard.

This latter format: MHP, employs an image-wise synchronization means. Through a message transmitted by the interactive application broadcasting device 235, for example CORAL (Thales Broadcast & Multimedia product) to the end user's decoder, the application knows the time base of the program. Thus the triggering commands comprise the instant in this time base of triggering of the broadcasting or of the activation of the interactive application. This instant corresponds to the instant in this same time base of the image formed by the primary data in which the secondary data forming this triggering command were watermarked.

FIG. 5a is a representation of the progress of an image and of the associated interactive application in the broadcasting channel according to the invention, corresponding to the use of an interactive system having the synchronization possibilities of the MHP standard. The first bold curve s₂₁₁ represents the program signal at the output of the reading device 211. This reading begins at the instant to and terminates at the instant tₙ. The image I₀ read at the instant to is the first image of the sequence. It is identified by secondary data transporting a synchronization message. The image I₁ is read at the instant t₁. The instants t are expressed in a universal time base bᵤ. This same program signal after coding by the coder 231 has undergone a certain delay as is represented in the second bold curve s₂₃₁. It begins at the instant T₀ and terminates at the instant Tₙ. These instants T are given in the time base specific to the program consisting of the primary data to which the interactive applications in question pertain. The image I₁* which corresponds to the coded image I₁ is provided at the instant T₁* by the coder 231. The third curve s₂₂₁ shows the instant t₀′ at which the synchronization datum associated with the first image I₀ of the sequence is read, and the instant t₁′ at which the secondary datum watermarked in the primary data of the image I₁ by the watermark reading device 221 is read. The last line gives the set in a universal time base the instants related to image I₁: the instant t₁ of reading of I₁, the instant t₁* of output of obtaining the coded image I₁*, the instant t₁′ of reading of the watermarked data in I₁.

Thus the triggering command, for example for activating the interactive application identified by the secondary datum watermarked in the image I₁, comprises not only the identifier of the interactive application to be activated, the code commanding the end user's decoder activation thereof, but also the instant at which it must be activated. This instant must be equal to T₁*, corresponding to the image I1 expressed in the time base of the program, with T₁*=T₀+(t₁′−t₀′). The reading device 220 receiving the signal s211 on its input e1 and the signal s231 on its input e2 can easily calculate (t₁′−t₀′), that is to say the gap between the instants of reading of the secondary data associated respectively with the images I₀ and I₁. It can moreover sample the value T₀ of the time base of the program present on e2 at the moment at which it transports the image I₀, still characterized by the secondary synchronization data. Once the value of T₁* has been calculated, the reading device immediately dispatches an activation command to the broadcasting device 235, before the instant of broadcasting of the image I*₁ (generally the reading time of the device 220 is much less than the coding time of the device 231).

Certain interactive systems, in particular OpenTV or MediaHighway do not employ activation commands that make reference to the time base of the primary data. Moreover, the decoder of the end user receiving signals of this type generally activates the interactive application as soon as the last packet comprising the interactive application is received. Specifically, the interactive application is segmented and transmitted in packets by way of the multiplexer 240, of the modulator 250 and of the antenna 260.

FIG. 5b is a representation of the progress of an image and of the associated interactive application in the broadcasting channel according to the invention, corresponding to the broadcasting signals of OpenTV or MediaHighway type. The first bold curve s₂₁₁ represents the program signal at the output of the reading device 211. This reading begins at the instant t₀ and terminates at the instant tₙ. The image I₀ read at the instant t₀ is the first image of the sequence and is identified by secondary data transporting a synchronization message. The image I₁ is read at the instant t₁. The instants t are expressed in a universal time base bᵤ. This same program signal after coding by the coder 231 has undergone a certain delay as is represented in the second bold curve s₂₃₁. The image I₁* which corresponds to the coded image I₁ is provided at the instant t₁* by the coder 231. The third curve s₂₁₁ shows the instant t₀′ at which the synchronization datum associated with the first image I₀ of the sequence is read, and the instant t₁′ at which the secondary datum watermarked in the primary data of the image I₁ by the watermark reading device 211 is read.

The fourth line gives the set in a universal time base the instants related to the image I₁: the instant t, of reading of I₁, the instant t₁* of output of obtaining of the coded image I₁*, the instant t₁′ of reading of the watermarked data in I₁.

To synchronize the triggering of the activation of the interactive application with the reproduction of the image in which the secondary data comprising this triggering command are watermarked, it is conceivable for the synchronization device 225 to give the order to the interactive applications broadcasting device 235 to transmit to the multiplexer 240 the interactive application's last packet identified A₁ at the instant at which the coder 231 transmits said image I₁* to the multiplexer 240 as shown by the last curve s₂₃₅. In particular to commence, the synchronization device 225 calculates the relative delay t₀*′−t₀′ induced by the coder 231. To do this, the synchronization device 225 can comprise a watermark reading device that profits from the a priori knowledge of the secondary data that it seeks to read from the primary data at the output of the coder 231. Thereafter, during the reading at t₁′ of the secondary data related to I₁, the reading device 221 knows when to despatch, via the module 225, a command for broadcasting the last packet of the application to the device 235, taking account of the delay time introduced by 231 and knowing its own time required to read the secondary information.

This example of synchronization of the secondary data with the primary data can also be applied to the MHP standard.

Other types of command reading system 220 may be envisaged having the same command function for controlling the interactive application broadcasting device 235. In general, the triggering commands emanating from the command reading system 220 are synchronized with the images in which the secondary data comprising these triggering commands are watermarked. The command reading system 220 may comprise one or more inputs. It receives the program signal with the primary data and the watermarked secondary data that has or has not undergone one or more processings. It furthermore receives the information necessary for performing the synchronizing, this information possibly being obtained from the abovementioned program signal.

The production and broadcasting channels described may be used not only for secondary data comprising interactive commands for application triggering but more generally for any type of secondary data. The use of secondary data watermarked in the primary data of the program may, in particular, allow program producers to transmit all types of commands to broadcasting systems, not only the commands for triggering interactive applications as was described previously but also various commands, for example meta data. As shown by FIG. 6, these meta data may, in particular, consist either of information, dubbed broadcasting application triggering commands in what follows, related to the actual broadcasting of the video program (number of broadcasts permitted, period of validity, broadcasting criterion (quality of the coding, etc), or information describing the program for the automatic generation of a program guide (EPG).

The production channel remains similar to that proposed by FIG. 2. The predetermined control criteria are then, for example, a function making it possible to determine the quality of coding as a function of one or more parameters of the primary data. In the broadcasting channel, the command reading system 220 may be coupled either to the interactive application broadcasting device 235 as described previously, or to the electronic program guide generator 233, or to the primary data coder 231, or to the multiplexer 240, etc as shown diagrammatically by FIG. 6 (this list given by way of example is nonlimiting). The command reading system 220 may whether or not the application triggering commands do or do not so require be synchronized with the primary data in which they are watermarked.

Moreover, the possibility of identifying the broadcasting channel for which the secondary data are destined, by virtue of an identifier of the broadcaster contained in these secondary data, makes it possible to envisage broadcasting applications commands, that is to say program broadcasting conditions, that are different for each broadcasting channel. Thus, the quality of coding desired may be different depending on the broadcasting channel.

The invention can be implemented for any recorded program having a passive main content and one or more interactive applications be it video, audio, etc intended to be broadcast in respect of television, radio, networks for cinemas or auditoria, etc. The interactive program is thus obtained for lower than existing costs. It is made attractive for the public in particular since no specific procedure needs to be performed (telephone, use of a computer keyboard, etc). It may create profit for the producer and/or the broadcaster. Specifically, once this system is available, it becomes very easy for producers of content and broadcasters to enhance audiovisual programs, by virtue of interactive applications that are very simple to create and are sources of direct revenues (via a commission on the telephone communications generated) or indirect revenues (via pre-purchase trialing of consumer products, etc).

1. A broadcasting program signal, comprising:
primary data for the reproduction of the passive main content of the program, wherein it comprises secondary data watermarked in the primary data not altering the reproduction of the main content of the primary data, and
secondary data comprise the commands for triggering at least one application related to the main content of the primary data.

2. The broadcasting program signal as claimed in claim 1, wherein said application triggering commands are commands for controlling one or more broadcasting parameters of said program signal and/or of one or more applications related to said program signal.

3. The broadcasting program signal as claimed in claim 2, wherein said broadcasting parameters of said program signal are the number of authorized broadcast and/or the period of validity and/or the desired quality of coding of said program signal.

4. The broadcasting program signal as claimed in claim 3, wherein said broadcasting parameters of one or more applications related to said program signal are a descriptor of said program for tile compilation of an electronic program guide.

5. The broadcasting program signal as claimed in claim 1, wherein said application triggering commands are commands for triggering the broadcasting and/or tile activation of at least one interactive application related to the main content of the primary data.

6. The broadcasting program signal as claimed in claim 5, wherein a triggering command comprises: an identifier of the interactive application relevant to this triggering command and a code giving the type of triggering to be performed.

7. The broadcasting program signal as claimed in claim 6, wherein the type of triggering code makes it possible to determine whether it is necessary to start or stop the broadcast and/or activate the identified application.

8. The broadcasting program signal as claimed in claim 1, where a triggering command comprises a code for identifying the broadcasting channel for which said command is designated.

9. A system for writing commands writing secondary data, allowing the triggering of at least one application, in a program signal comprising at least primary data for the reproduction of the passive main content of the program comprising:
a first input e₁ receiving primary data for the reproduction of the passive main content of the program;
a watermarking device receiving the primary data of the first input e₁ and secondary data, and generating a program signal comprising the primary data and the secondary data watermarked in the primary data, said watermarking not altering the reproduction of the main content of the primary data;
an output coupled to the output of the watermarking device;
a second input e₂ receiving predetermined control criteria,
a reproduction and editing device coupled to the first and second inputs e₁ and e₂, said device reproducing the main content of the primary data, which content is received on the first input e₁, and editing on its output at least one secondary datum making it possible to control the triggering of at least one application related to the main content of the primary data, which application is reproduced according to the predetermined control criteria received on this second input e₂.

10. The command writing system as claimed in claim 9, wherein
the predetermined control criteria are predetermined interactivity criteria,
said reproduction and editing device edits on its output at least one secondary datum making it possible to control the triggering of the broadcasting and/or of the activation of at least one interactive application related to the main content of the primary data, which application is reproduced at this instant according to said predetermined interactivity criteria received on this second input e₂.

11. The command writing system as claimed in claim 9, wherein tho program signal generated by said watermarking device is a program signal as claimed in claim.

12. A production channel comprising in series a system for producing a program signal comprising primary data for the reproduction of the passive main content of the program and a command writing system as claimed in claim 10.

13. A system for reading a command in a program signal comprising primary data for the reproduction of the passive main content of the program and at least one secondary datum watermarked in the primary data comprising:
a first input receiving the program signal,
a watermark reading device, reading the secondary data watermarked in the primary data,
the secondary data comprises commands for triggering at least one application related to the main content of the primary data, and in that
said command reading system comprises an output receiving said application triggering commands.

14. The command reading system as claimed claim 15, wherein the program signal received on its first input is a program signal as claimed in any one of claim.

15. The command reading system as claimed in claim 13, wherein:
the secondary data comprises commands for triggering the broadcasting and/or the activation of at least one interactive application related to the main content of the primary data, and
said command reading system comprises an output receiving triggering commands synchronized such that the activation and/or the broadcasting of the interactive applications identified by the triggering commands is synchronized with the reproduction of the primary data in which the secondary data associated with these triggering commands are watermarked.

16. The command reading system as claimed in claim 15, which system comprises a synchronization device receiving at least the secondary data and generating synchronized triggering commands.

17. A program broadcasting channel comprising several devices, comprising:
a device for reading a program signal comprising primary data for the reproduction of the passive main content of the program and at least one secondary datum watermarked in the primary data,
a program signal coder coupled to the output of said program signal reading device,
and/or an interactive applications server, a device for broadcasting interactive applications coupled to said interactive applications server,
a multiplexer coupled at least to the output of the program signal coder and/or to the interactive applications broadcasting device,
a command reading system coupled to the output of said program signal reading device and/or to the output of said program signal coder,
a coupling of said command reading system with at least any one of the devices of said broadcasting channel, the triggering commands generated by the command reading system controlling said device of said broadcasting channel, which device is coupled to said command reading system.

18. The program broadcasting channel as claimed in claim 17, wherein said command reading system is coupled to said interactive applications broadcasting device, the triggering commands generated by the command reading system controlling the transmission of the interactive applications originating from said interactive applications server to the multiplexer and/or the transmission to the multiplexer of the order for activation of one or more interactive applications identified by these triggering commands.

19. The program broadcasting channel as claimed in claim 18, wherein the synchronized triggering command for activating the interactive application identified generated by the synchronization device controls the transmission by the interactive applications broadcasting device of the last packet of the interactive application identified to the multiplexer triggering the activation of this interactive application.

20. The program broadcasting channel as claimed in claim 18, wherein the synchronized triggering command for activating the interactive application identified generated by the synchronization device comprises the instant of triggering of the activation of the interactive application identified in the time base of the program, this instant corresponding to the instant of broadcasting the primary data in which the secondary data associated with this triggering command are watermarked.

21. The broadcasting program signal as claimed in claim 2, wherein said application triggering commands are commands for triggering the broadcasting and/or the activation of at least one interactive application related to the main content of the primary data.

22. The command writing system as claimed in claim 10, wherein the program signal generated by said watermarking device is a program signal as claimed in claim 1.

23. The command reading system as claimed in claim 14, wherein:
the secondary data comprises commands for triggering the broadcasting and/or the activation of at least one interactive application related to the main content of the primary data, and
said command reading system comprises an output receiving triggering commands synchronized such that the activation and/or the broadcasting of the interactive applications identified by the triggering commands is synchronized with the reproduction of the primary data in which the secondary data associated with these triggering commands are watermarked.
